(19) United States
(12) Patent Application Publication
(10) Pub. No.: US 2017/0118650 A1
(43) Pub. Date: Apr. 27, 2017

(54) WI-FI CONNECTING METHOD, TERMINAL AND SYSTEM

(71) Applicants: LE HOLDINGS (BEIJING) CO., LTD., Beijing (CN); Lemobile Information Technology (Beijing)Co., Ltd., Beijing (CN)

(72) Inventor: Yan YU, Beijing (CN)

(21) Appl. No.: 15/247,700

(22) Filed: Aug. 25, 2016

Related U.S. Application Data
(63) Continuation of application No. PCT/CN2016/087026, filed on Jun. 24, 2016.

(30) Foreign Application Priority Data
Oct. 22, 2015 (CN) 201510694436.X

(51) Int. Cl. H04W 12/08; H04W 12/04; H04L 29/06; H04W 12/06

(52) U.S. Cl. CPC H04W 12/08; H04W 12/06; H04W 12/04; H04L 63/061; H04L 63/0861; H04L 63/10; H04L 63/0428

(57) ABSTRACT

An embodiment of the present disclosure discloses a Wi-Fi connecting method, a terminal and a system. The method comprises: scanning fingerprint of a user, acquiring characteristic of the fingerprint, sending the characteristic of the fingerprint to a wireless router to be saved by the wireless router, by a test terminal; receiving a request for acquiring characteristic of the fingerprint sent by a second terminal and sending the characteristic of the fingerprint to the second terminal, by the first terminal; wherein the second terminal sends a Wi-Fi connecting request with the characteristic of the fingerprint to the wireless router after acquiring the characteristic of the fingerprint from the first terminal, and connects to Wi-Fi if the characteristic of the fingerprint in the Wi-Fi connecting request matches the characteristic of the fingerprint saved in the wireless router.

### CROSS-REFERENCE TO RELATED APPLICATIONS

The present disclosure is a continuation of International Application No. PCT/CN2016/087026, filed on Jun. 24, 2016; which is based upon and claims priority to Chinese Patent Application No. 201510694436.X, entitled “WI-FI CONNECTING METHOD, TERMINAL AND SYSTEM”, filed on Oct. 22, 2015 the entire contents of all of which are incorporated herein by reference.

### TECHNICAL FIELD

The present disclosure generally relates to the field of technology of the Internet security and particularly relates to a Wi-Fi connecting method, a terminal and a system.

### BACKGROUND

Wi-Fi (Wireless-Fidelity) is a technology for interconnecting terminals such as personal computers, handheld devices (for example, tablet personal computers, mobile phones) and the like in a wireless manner; in fact, the signal via Wi-Fi is a high-frequency radio signal.

At present, the phenomenon of the stealing of Wi-Fi is relatively common; in order to prevent Wi-Fi from being stolen, the user often sets a Wi-Fi password on as wireless router. When the terminal is connected to Wi-Fi via the wireless router, the user needs to choose the name of the wireless router required to be connected on the terminal and fills the corresponding Wi-Fi password. The wireless router cheeks whether the Wi-Fi password filled by the user is correct or not; if the Wi-Fi password is correct, the terminal is allowed to be connected to Wi-Fi; if the Wi-Fi password is wrong, the terminal is forbidden to be connected to Wi-Fi, thereby preventing Wi-Fi from being stolen. However, the Wi-Fi password set by the user is a character string composed of letters, numbers and underlines; such character string often has a certain regularity, is easily decoded by network thieves and is relatively low in security.

Therefore, the problem to be solved by those of ordinary skill in the at is about how to improve the security of Wi-Fi password and prevent Wi-Fi password from being stolen.

### SUMMARY

An embodiment of the present disclosure discloses a Wi-Fi connecting method, a terminal and a system and aims to solve the problems that the Wi-Fi password set by the user in the wireless router is relatively simple and the Wi-Fi network is easily stolen in the prior art.

According to one aspect of the present disclosure, the present disclosure discloses a Wi-Fi connecting method, including the following steps:
scanning fingerprint of a user, acquiring characteristic of the fingerprint, sending the characteristic of the fingerprint to a wireless router to be saved by the wireless router, by a first terminal;
receiving a request for acquiring characteristic, of the fingerprint sent by a second terminal and sending the characteristic of the fingerprint to the second terminal, by the first terminal;
wherein the second terminal sends a Wi-Fi connecting request with the characteristic of the fingerprint to the wireless router after acquiring the characteristic of the fingerprint from the first terminal, and connects to Wi-Fi if the characteristic of the fingerprint in the Wi-Fi connecting request matches the characteristic of the fingerprint saved in the wireless router.

According to another aspect of the present disclosure, the present disclosure also discloses an electronic, device, including: at least one first processor; and a memory communicably connected with the at least one first processor for storing instructions executable by the at least one first processor, wherein execution of the instructions by the at least one first processor causes the at least one first processor to:
scan fingerprint of a user, acquire characteristic of the fingerprint, send the characteristic of the fingerprint to a wireless router to be saved by the wireless router; and
receive a request for acquiring characteristic of the fingerprint sent by a second terminal and send the characteristic of the fingerprint to the second terminal;
wherein the second terminal sends a Wi-Fi connecting request with the characteristic of the fingerprint to the wireless router after acquiring the characteristic of the fingerprint from the electronic device, and connects to Wi-Fi if the characteristic of the fingerprint in the Wi-Fi connecting request matches the characteristic of the fingerprint saved in the wireless router.

According to another aspect of the present disclosure, the present disclosure also discloses an electronic device, including: at least one second processor; and a second memory communicably connected with the at least one second processor for storing instructions executable by the at least one second processor; wherein execution of the instructions by the at least one second processor causes the at least one second processor to:
receive and save characteristic of the fingerprint sent by a first terminal; and
receive a Wi-Fi connecting request sent by a second terminal, check whether characteristic of the fingerprint in the Wi-Fi connecting request is consistent with the characteristic of the fingerprint sent by the first terminal, and if yes, allow the second terminal to be connected to Wi-Fi.

According to the method, the electronic device provided by the embodiment of the present disclosure, the fingerprint characteristic of the user is used as a Wi-Fi connecting password; the fingerprint characteristic is relatively complex and has uniqueness, so that the complexity of the Wi-Fi password is improved, the Wi-Fi password is not easily decoded by hackers, and the security of the network is improved.

The above description is merely taken as the summary of the technical solutions of the present disclosure. In order to understand the technical manners of the present disclosure more apparently, the present disclosure can be implemented according to the content of the description. Furthermore, in order to enable the above purpose, other purposes, characteristics and advantages of the present disclosure to be more obvious and understandable, the specific embodiments of the present disclosure are particularly shown below.

### BRIEF DESCRIPTION OF THE DRAWINGS

In order to illustrate the technical solutions of the embodiments of the present disclosure or the prior art, the drawings needed to be used in the description of the embodiments or the prior art are briefly introduced below. Apparently, the drawings described below are taken as some embodiments of the present disclosure. Those of ordinary skill in the art also can acquire other drawings according to the drawings under the premise of not contributing the creative labor.

FIG. 1 is a step flow diagram of a Wi-Fi connecting method provided by the embodiment of the present disclosure.

FIG. 2 is a step flow diagram of a Wi-Fi connecting method provided by the embodiment of the present disclosure.

FIG. 3 is a step flow diagram of a Wi-Fi connecting method provided by the embodiment of the present disclosure.

FIG. 4 is a step flow diagram of a Wi-Fi connecting method provided by the embodiment of the present disclosure.

FIG. 5 is a structural schematic diagram of a Wi-Fi connecting terminal provided by the embodiment of the present disclosure.

FIG. 6 is a structural schematic diagram of a Wi-Fi connecting terminal provided by the embodiment of the present disclosure.

FIG. 7 is a structural schematic diagram of a Wi-Fi connecting wireless router provided by the embodiment of the present disclosure.

FIG. 8 is a structural schematic diagram of a Wi-Fi connecting system provided by the embodiment of the present disclosure.

FIG. 9 schematically illustrates a block diagram of an electronic device used for performing the method according to the present disclosure. and

FIG. 10 schematically illustrates a storage unit used for keeping or carrying a program code for implementing the method according to the present disclosure.

### DETAILED DESCRIPTION

In order to enable the purpose, the technical solutions and the advantages of the embodiment of the present disclosure to be more apparent, the technical solutions of the embodiments of the present disclosure will be clearly and completely described below by combining the drawings in the embodiments of the present disclosure. Apparently, the described embodiments are taken as part of embodiments of the present disclosure rather than all of the embodiments. All the other embodiments acquired by those of ordinary skill in the art based on the embodiments of the present disclosure under the premise of not contributing the creative labor fall within the scope of protection of the present disclosure.

### Embodiment 1

Referring to FIG. 1, a step flow diagram of a Wi-Fi connecting method provided by the embodiment of the present disclosure is shown.

An embodiment of the present disclosure provides a Wi-Fi connecting method. As shown in FIG. 1, the method may include the steps as follows.

Step S101, scanning fingerprint of a user via a first terminal, acquiring characteristic of the fingerprint, sending the characteristic of the fingerprint to a wireless router and saving the characteristic of the fingerprint in the wireless router.

In this step, the first terminal is a terminal owned by a Wi-Fi network owner, a fingerprint scanner can be arranged in the terminal, and the fingerprint of the user can be scanned by the fingerprint scanner. The characteristic of the fingerprint may include at least one of the position of a capillary pore of the finger, the endpoint of the raised line on the epidermis of the finger and the cross point of the raised line on the epidermis of the finger, and generally, at least two characteristics of one fingerprint are needed to be acquired.

Step S102, receiving a request for acquiring characteristic of the fingerprint sent by a second terminal and sending the characteristic of the fingerprint to the second terminal, by the first terminal.

In this step, the second terminal is a terminal owned by a Wi-Fi network visitor. The second terminal sends the request for acquiring characteristic of the fingerprint to the first terminal when the Wi-Fi visitor needs to visit the Wi-Fi network so as to connect to a wireless network via the characteristic of the fingerprint.

Step S103, acquiring the characteristic of the fingerprint, sending a Wi-Fi connecting request with the characteristic of the fingerprint to the wireless router and connecting to Wi-Fi if the Wi-Fi connecting request is approved, by the second terminal.

In this step, the wireless router receives the characteristic of the fingerprint sent by the second terminal and compares the characteristic of the fingerprint sent by the second terminal with the saved characteristic of the fingerprint; if yes, the Wi-Fi connecting request is approved and the second terminal is allowed to be connected to Wi-Fi; and if not the Wi-Fi connecting request is not approved and the second terminal is not allowed to be connected to Wi-Fi.

According to the Wi-Fi connecting method provided by the embodiment of the present disclosure, the characteristic of the fingerprint of the user is used as a Wi-Fi connecting password; the characteristic of the fingerprint is relatively complex and has uniqueness, so that the complexity of the Wi-Fi password is improved, the Wi-Fi password is not easily decoded by hackers, and the security of the network is improved.

### Embodiment 2

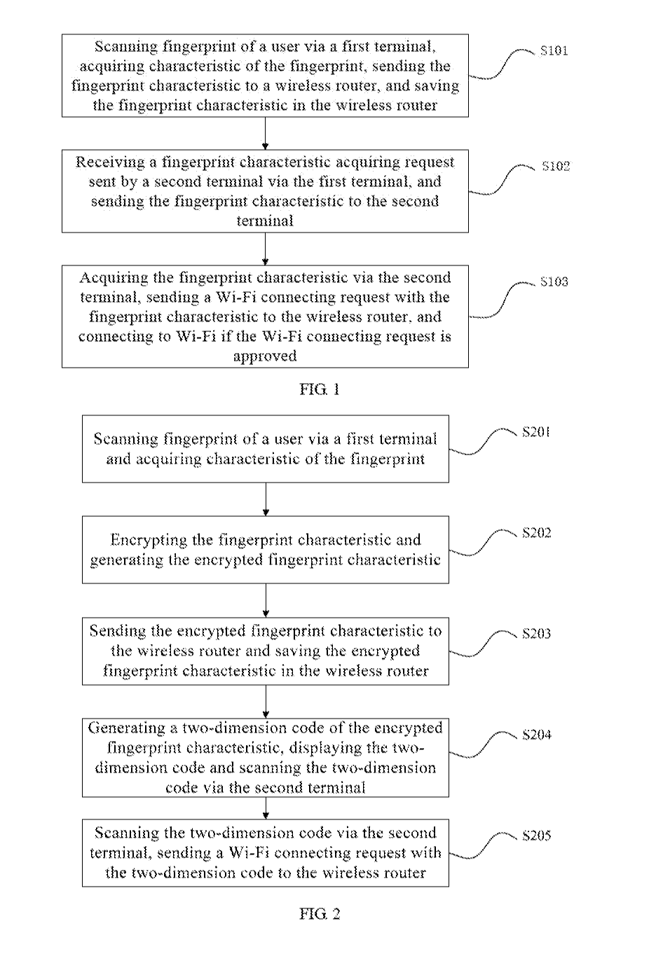

Referring to FIG. 2, a step flow diagram of a Wi-Fi connecting method provided by the embodiment of the present disclosure is shown.

The embodiment of the present disclosure provides a Wi-Fi connecting method. As shown in FIG. 2, the method may include the steps as follows.

Step S201, scanning the fingerprint of a user and acquiring characteristic of the fingerprint, by a first terminal.

Step S202, encrypting the characteristic of the fingerprint and generating the encrypted characteristic of the fingerprint.

In this step, in order to improve the security of the Wi-Fi password, the first terminal may encrypt the characteristic of the fingerprint according to a preset secret key and generate the encrypted characteristic of the fingerprint.

Step S203, sending the encrypted characteristic of the fingerprint to the wireless router and saving the encrypted characteristic of the fingerprint in the wireless router.

Step S204, receiving a request for acquiring characteristic of the fingerprint sent by the second terminal, generating a two-dimension code of the encrypted characteristic of the fingerprint, displaying the two-dimension code to be scanned by the second terminal, by the first terminal.

In this step, the generation of the two-dimension code of the encrypted characteristic of the fingerprint is the secondary encryption on the encrypted characteristic of the fingerprint so as to prevent, the encrypted characteristic of the fingerprint from being decoded by the hackers and improve the security of the network.

Step S205, scanning the two-dimension code, sending a Wi-Fi connecting request with the two-dimension code to the wireless router and connecting to Wi-Fi if the Wi-Fi connecting request is approved, by the second terminal.

According to the Wi-Fi connecting method provided by the embodiment of the present disclosure, the encrypted characteristic of the fingerprint is used as a Wi-Fi connecting password, so that the complexity of the Wi-Fi password is improved, and the Wi-Fi password is not easily decoded by hackers furthermore, the two-dimension code transmission is adopted in the process of transmitting the Wi-Fi password to the second terminal, so that the security of the network is further improved.

### Embodiment 3

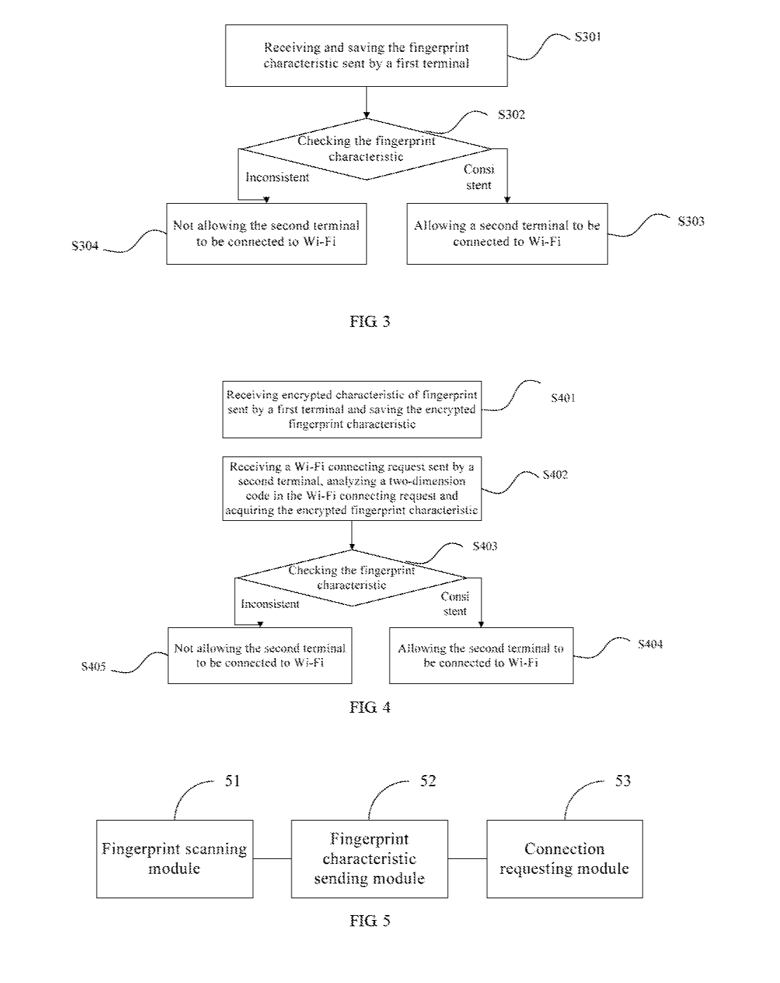

Referring to FIG. 3, a step flow diagram of a Wi-Fi connecting method provided by the embodiment of the present disclosure is shown.

The embodiment of the present disclosure provides a Wi-Fi connecting method. As shown in FIG. 3, the method may include the steps as follows.

Step S301, receiving and saving the characteristic of the fingerprint sent by a first terminal.

Step S302, receiving a Wi-Fi connecting request sent by a second terminal and checking whether the characteristic of the fingerprint in the Wi-Fi connecting request is consistent with the characteristic of the fingerprint sent by the first terminal or not.

In the step, if yes, performing the step S303, and if not, performing the step S304.

Step S303, allowing the second terminal to be connected to

Step S304, not allowing the second terminal to be connected to Wi-Fi.

In this step, a message for indicating that the Wi-Fi password is wrong can also be fed back to the second terminal so as to remind a visitor owning the second terminal of re-inputting password.

Through the Wi-Fi connecting method provided by the embodiment of the present disclosure, the characteristic of the fingerprint can be checked to determine whether to provide Wi-Fi; and the security of the network is improved.

### Embodiment 4

Referring to FIG. 4, a step flow diagram of a Wi-Fi connecting method provided by the embodiment of the present disclosure is shown.

The embodiment of the present disclosure provides a Wi-Fi connecting method. As shown in FIG. 4, the method may include the steps as follows.

Step S401, receiving encrypted characteristic of the fingerprint sent by a first terminal and saving the encrypted characteristic of the fingerprint.

Step S402, receiving a Wi-Fi connecting request sent by a second terminal, analyzing a two-dimension code in the Wi-Fi connecting request and acquiring the encrypted characteristic of the fingerprint.

Step S403, checking whether the saved encrypted characteristic of the fingerprint is consistent with the encrypted characteristic of the fingerprint acquired by analyzing or not.

In this step, if yes, performing the step S404, and if not, performing the step S405.

Step S404, allowing the second terminal to be connected to Wi-Fi.

Step S405, not allowing the second terminal to be connected to Wi-Fi.

In this step, a message for indicating that the Wi-Fi password is wrong, may also be fed back to the second terminal so as to remind a visitor owning the second terminal of re-inputting password.

Through the Wi-Fi connecting method provided by the embodiment of the present disclosure, the two-dimension code sent by the second terminal may be analyzed to acquire the characteristic of the fingerprint; and the characteristic of the fingerprint is checked to determine whether to provide thereby improving the security of the network.

### Embodiment 5

Referring to FIG. 5, a structural schematic diagram of a Wi-Fi connecting terminal provided by the embodiment of the present disclosure is shown.

The embodiment of the present disclosure provides a Wi-Fi connecting terminal. The terminal can perform a Wi-Fi connecting method provided by the embodiment 1 of the present disclosure. As shown in FIG. 5, the terminal includes: a fingerprint scanning module 51, a fingerprint characteristic sending module 52 and a connection requesting module 53.

In the embodiment of the present disclosure, the fingerprint scanning module 51 is used for scanning fingerprint of a user, acquiring characteristic of the fingerprint, sending the characteristic of the fingerprint to a wireless router to be saved by the wireless router; the fingerprint characteristic sending module 52 is used for receiving requests for acquiring characteristic of the fingerprint sent by other terminals and sending the characteristic of the fingerprint to the other terminals; the connection requesting module 53 is used for acquiring the characteristic of the fingerprint and sending a Wi-Fi connecting request to a wireless router; the Wi-Fi connecting request includes the characteristic of the fingerprint; if the Wi-Fi connecting request is approved, the Wi-Fi is connected.

In the fingerprint scanning module 51, a fingerprint scanner may be arranged in the terminal; and the fingerprint of the user can he scanned by the fingerprint scantier. The characteristic of the fingerprint may include at least one of the position of a capillary pore of the finger, the endpoint of the raised line on the epidermis of the finger and the cross point of the raised lines on the epidermis of the finger, and generally, at least two characteristics of one fingerprint are needed to be acquired.

In the fingerprint characteristic sending module 52, when a Wi-Fi visitor needs to visit a Wi-Fi network, a second terminal sends a request for acquiring characteristic of the fingerprint to a first terminal so as to connect to a wireless network by means of the acquired characteristic of the fingerprint.

In the connection requesting module 53, the wireless router receives the characteristic of the fingerprint sent by the second terminal and compares the characteristic of the fingerprint sent by the second terminal with the saved characteristic of the fingerprint; if the characteristic of the fingerprint sent by the second terminal is consistent with the saved characteristic of the fingerprint, the second terminal is allowed to be connected to Wi-Fi if the connecting request is approved; if the characteristic of the fingerprint sent by the second terminal is inconsistent with the saved characteristic of the fingerprint, the second terminal is not allowed to be connected to Wi-Fi.

According to the Wi-Fi connecting wireless router provided by the embodiment of the present disclosure, the characteristic of the fingerprint of the user is used as a Wi-Fi connecting password; the characteristic, of the fingerprint is relatively complex and has uniqueness, so that the complexity of the Wi-Fi password is improved, the Wi-Fi password is not easily decoded by hackers, and the security of the network is improved.

### Embodiment 6

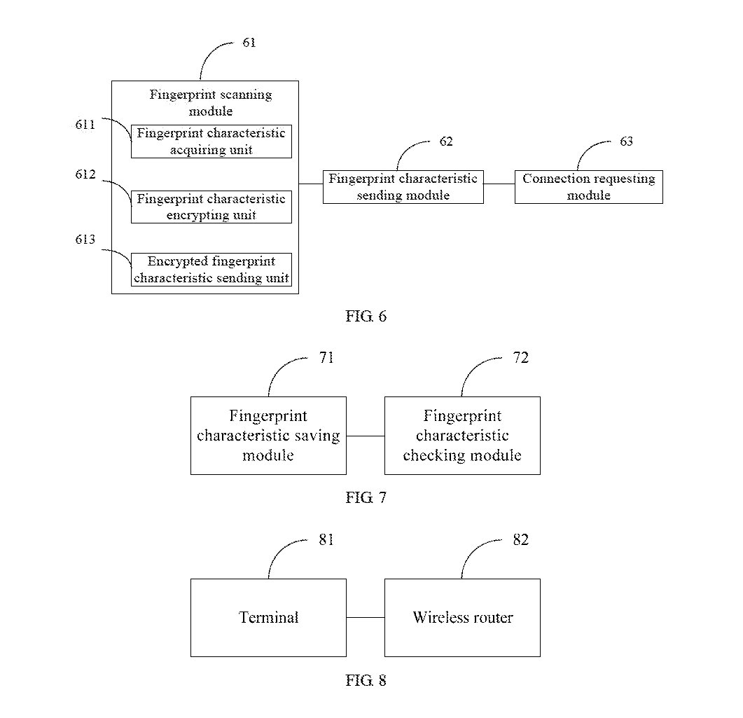

Referring to FIG. 6, a structural schematic diagram of a Wi-Fi connecting terminal provided by the embodiment of the present disclosure is shown.

The embodiment of the present disclosure provides a Wi-Fi connecting terminal. As shown in FIG. 6, the terminal includes: a fingerprint scanning module 61, a fingerprint characteristic sending module 62 and a connection requesting module 63; the fingerprint scanning module 61 includes a fingerprint characteristic, acquiring unit 611, a fingerprint characteristic encrypting unit 612 and an encrypted fingerprint characteristic sending unit 613.

In the embodiment of the present disclosure, the fingerprint scanning module 61 includes a fingerprint characteristic acquiring unit 611 used for scanning fingerprint of a user and acquiring characteristic of the fingerprint via a first terminal; the fingerprint characteristic encrypting unit 612 is used for encrypting the characteristic of the fingerprint and generating the encrypted characteristic of the fingerprint; the encrypted fingerprint characteristic sending unit 613 is used for sending the encrypted characteristic of the fingerprint to a wireless router to be saved by the wireless router; and the fingerprint characteristic sending module 62 is specifically used for generating a two-dimension code of the encrypted characteristic of the fingerprint according to a request for acquiring characteristic of the fingerprint sent by a second terminal, displaying the two-dimension code to be scanned by the second terminal. The connection requesting module 63 is specifically used for scanning the two-dimension code and sending a Wi-Fi connecting request to a wireless router; the Wi-Fi connecting request includes the two-dimension code; if the Wi-Fi connecting request is approved, Wi-Fi is connected.

In the fingerprint characteristic encrypting unit 612, in order to improve the security of the Wi-Fi password, the terminal can encrypt the characteristic of the fingerprint according to a preset key and generate the encrypted characteristic of the fingerprint.

In the fingerprint characteristic sending module 62, the generation of the two-dimension code of the encrypted characteristic of the fingerprint is the secondary encryption on the encrypted characteristic of the fingerprint so as to prevent the encrypted characteristic of the fingerprint from being decoded by the hackers and improve the security of the network.

According to the Wi-Fi connecting wireless router provided by the embodiment of the present disclosure, the encrypted characteristic of the fingerprint is used as a Wi-Fi connecting password, so that the complexity of the Wi-Fi password is improved, and the Wi-Fi password is not easily decoded by hackers; furthermore, the two-dimension code transmission is adopted in the process of transmitting the Wi-Fi password to the second terminal, so that the security of the network is further improved.

### Embodiment 7

Referring, to FIG. 7, a structural schematic diagram of as Wi-Fi connecting wireless router provided by the embodiment of the present disclosure is shown.

The embodiment of the present disclosure provides a Wi-Fi connecting wireless router. As shown in FIG. 7, the wireless router includes: a fingerprint characteristic saving module 71 and a fingerprint characteristic checking module 72.

In the embodiment of the present disclosure, the fingerprint characteristic saving module 71 is used for receiving and saving characteristic of the fingerprint sent by a first terminal; the fingerprint characteristic checking Module n is used for receiving a Wi-Fi connecting request sent by a second terminal, checking Whether the characteristic of the fingerprint in the Wi-Fi connecting request is consistent with the characteristic of the fingerprint sent by the first terminal or not, and if yes, allowing the second terminal to be connected to Wi-Fi.

Through the Wi-Fi connecting wireless router provided by the embodiment of the present disclosure, the characteristic of the fingerprint can be checked to determine whether to provide Wi-Fi connection: and the security of the network is improved.

The present disclosure provides a preferred embodiment. The fingerprint characteristic saving module 71 can be optimized to be used for receiving the encrypted characteristic of the fingerprint sent by the first terminal and saving the encrypted characteristic of the fingerprint.

The fingerprint characteristic checking module 72 can be optimized to be used for receiving a Wi-Fi connecting request sent by the second terminal, analyzing the two-dimension code in the Wi-Fi connecting request, acquiring the encrypted characteristic of the fingerprint, checking whether the saved and encrypted characteristic of the fingerprint is consistent with the encrypted characteristic of the fingerprint acquired by analyzing or not, and if yes, allowing the second terminal to be connected to Wi-Fi.

Through the preferred embodiment provided by the present disclosure, the two-dimension code sent by the second terminal may be analyzed to acquire the characteristic of the fingerprint; the characteristic of the fingerprint can be checked to determine whether to provide Wi-Fi connection; and the security of the network is improved.

### Embodiment 8

Referring to FIG. 8, a structural schematic diagram of a Wi-Fi connecting system provided by the embodiment of the present disclosure is shown.

The embodiment of the present invention provides a Wi-Fi connecting system. As shown in FIG. 8, the system may include the terminal 81 provided by the embodiment 5 and the embodiment 6 and the wireless router 82 provided by the embodiment 8.

According to the Wi-Fi connecting system provided by the embodiment of the present disclosure, the characteristic of the fingerprint of the user is used as a Wi-Fi connecting password; the characteristic of the fingerprint is relatively complex and has uniqueness, so that the complexity of the Wi-Fi password is improved, the Wi-Fi password is not easily decoded by hackers, and the security of the network is improved.

Device embodiments described above are merely schematic; units illustrated as separate parts can or cannot be physically separated; parts displayed as units can or cannot be physical units, namely the parts can be located on one place or can be distributed on multiple network units. The purposes of the solutions of the embodiments can be achieved by selecting part or all of the modules according to the actual need. Those of ordinary skill in the art can understand and implement the solutions of the embodiments in the case of no contribution of creative labor.

Each of devices according to the embodiments of the disclosure can be implemented by hardware, or implemented by software modules operating on one or more processors, or implemented by the combination thereof A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the interne websites, or be provided in carrier, or be provided in other manners.

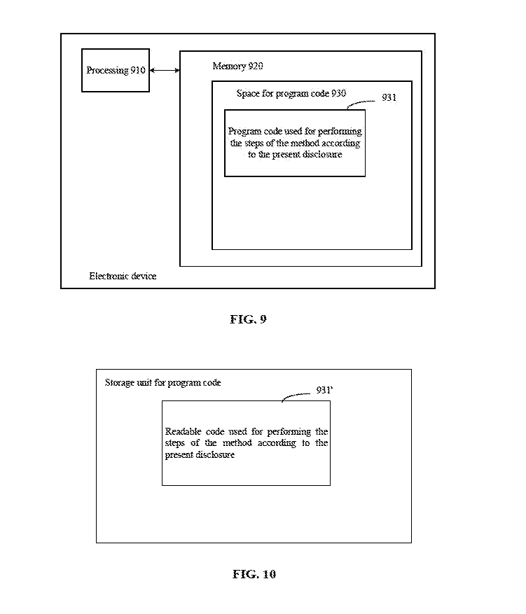

For example, FIG. 9 illustrates a block diagram of an electronic device for executing the method according the disclosure such as the Wi-Fi connecting terminal or Wi-Fi connecting wireless router. Traditionally, the electronic device includes a processor 910 and a computer program product or a computer readable medium in form of a memory 920. The memory 920 could be electronic memories such as flash memory, EEPROM (Electrically Erasable Programmable Read-Only Memory), EPROM, hard disk or ROM. The memory 920 has a memory space 930 for executing program codes 931 of any steps in the above methods. For example, the memory space 930 for program codes may include respective program codes 931 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 10. The memory cells may be provided with memory sections, memory spaces, etc., similar to the memory 920 of the server as shown in FIG. 9. The program codes may be compressed for example in an appropriate form. Usually, the memory cell includes computer readable codes 931′ which can be read for example by processors 910. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would he included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may he realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be illustrated that the above embodiments are merely used for illustrating the technical solutions of the present disclosure rather than limiting the technical solutions of the present disclosure. Although the present disclosure is illustrated in detail with reference to the above embodiments, those of ordinary skill in the art should understand that the technical solutions recorded in the above embodiments can still be modified or part of the technical characteristics can be equivalently replaced; and the modifications or the replacements can enable the essence of the corresponding technical solution to fall within the spirit and the scope of the technical solutions of the embodiments of the present disclosure.

What is claimed is:

1. A connecting method, comprising:
scanning fingerprint of a user, acquiring characteristic of the fingerprint sending the characteristic of the fingerprint to a wireless router to be saved by the wireless router, by a first terminal;
receiving a request for acquiring characteristic of the fingerprint sent by a second terminal and sending the characteristic of the fingerprint to the second terminal, by the first terminal;
wherein the second terminal sends a Wi-Fi connecting request with the characteristic of the fingerprint to the wireless router after acquiring the characteristic of the fingerprint from the first terminal, and connects to Wi-Fi if the characteristic of the fingerprint in the Wi-Fi connecting request matches the characteristic of the fingerprint saved in the wireless router.

2. The method according to claim 1, wherein scanning fingerprint of the user, acquiring the characteristic of the fingerprint, sending the characteristic of the fingerprint to the wireless router to be saved by the wireless router by the first terminal comprises:
scanning the fingerprint of the user and acquiring the characteristic of the fingerprint, by the first terminal;
encrypting the characteristic of the fingerprint and generating the encrypted characteristic of the fingerprint; and
sending the encrypted characteristic of the fingerprint to the wireless router to be saved by the wireless router.

3. The method according to claim 1, wherein receiving a request for acquiring characteristic of the fingerprint sent by a second terminal and sending the characteristic of the fingerprint to the second terminal, by the first terminal comprises:
receiving the request for acquiring characteristic of the fingerprint sent by the second terminal, generating a two-dimension code of the encrypted characteristic of the fingerprint, displaying the two-dimension code to be scanned by the second terminal, by the first terminal.

4. The method according to claim 3, wherein the second terminal sends a Wi-Fi connecting request with the characteristic of the fingerprint to the wireless router after acquiring the characteristic of the fingerprint from the first terminal, and connects to Wi-Fi if the characteristic of the fingerprint in the Wi-Fi connecting request matches the characteristic of the fingerprint saved in the wireless router comprises:
the second terminal scans the two-dimension code, sends the Wi-Fi connecting request with the two-dimension code to the wireless router after acquiring the two-dimensional code from the first terminal, and connects to Wi-Fi if the two-dimensional code in the Wi-Fi connecting request matches the two-dimensional code in the wireless router.

5. An electronic device, comprising:
at least one first processor; and
a memory communicably connected with the at least one first processor for storing instructions executable by the at least one first processor, wherein execution of the instructions by the at least one first processor causes the at least one first processor to:
scan fingerprint of a user, acquire characteristic of the fingerprint, send the characteristic of the fingerprint to a wireless router to be saved by the wireless router; and
receive a request for acquiring characteristic of the fingerprint sent by a second terminal and send the characteristic of the fingerprint to the second terminal:
wherein the second terminal sends a Wi-Fi connecting request with the characteristic of the fingerprint to the wireless router after acquiring the characteristic of the fingerprint from the electronic device, and connects to Wi-Fi if the characteristic of the fingerprint in the Wi-Fi connecting request matches the characteristic of the fingerprint saved in the wireless router.

6. The electronic device according to claim 5, wherein scan fingerprint of the user, acquiring the characteristic of the fingerprint, sending the characteristic of the fingerprint to the wireless router to be saved by the wireless router by the electronic device comprises:
scanning the fingerprint of the user and acquiring the characteristic of the fingerprint, by the electronic device;
encrypting the characteristic of the fingerprint and generating the encrypted characteristic of the fingerprint; and
sending the encrypted characteristic of the fingerprint to the wireless router to be saved by the wireless router.

7. The electronic device according to claim 5 wherein receive a request for acquiring characteristic of the fingerprint sent by a second terminal and send the characteristic of the fingerprint to the second terminal, by the electronic device comprises:
receiving the request for acquiring characteristic of the fingerprint sent by the second terminal, generating a two-dimension code of the encrypted characteristic of the fingerprint, displaying the two-dimension code to be scanned by the second terminal, by the electronic device.

8. The electronic device according to claim 7, wherein the second terminal sends a Wi-Fi connecting request with the characteristic of the fingerprint to the wireless router after acquiring the characteristic of the fingerprint from the electronic device, and connects to Wi-Fi if the characteristic of the fingerprint in the Wi-Fi connecting request matches the characteristic of the fingerprint saved in the wireless router comprises:
the second terminal scans the two-dimension code, sends the Wi-Fi connecting request with the two-dimension code to the wireless router after acquiring the two-dimensional code from the electronic device, and connects to Wi-Fi if the two-dimensional code in the Wi-Fi connecting request matches the two-dimensional code in the wireless router.

9. An electronic device, comprising:
at least one second processor; and
a second memory communicably connected with the at least one second processor for storing instructions executable by the at least one second processor, wherein execution of the instructions by the at least one second processor causes the at least one second processor to:
receive and save characteristic of the fingerprint sent by a first terminal; and
receive a Wi-Fi connecting request sent by a second terminal, check whether characteristic of the fingerprint in the Wi-Fi connecting request is consistent with the characteristic of the fingerprint sent by the first terminal, and if yes, allow the second terminal to be connected to Wi-Fi.

10. The electronic device according to claim 9, wherein:
receive and save characteristic of the fingerprint sent by the first terminal comprises:
receiving the encrypted characteristic of the fingerprint sent by the first terminal and saving the encrypted characteristic of the fingerprint;
receiving a Wi-Fi connecting request sent by a second terminal, check whether characteristic of the fingerprint in the Wi-Fi connecting request is consistent with the characteristic of the fingerprint sent by the first terminal, and if yes, allow the second terminal to be connected to Wi-Fi comprises:
receiving the Wi-Fi connecting request sent by the second terminal, analyzing the two-dimension code in the Wi-Fi connecting request and acquiring the encrypted characteristic of the fingerprint; and checking whether the saved and encrypted characteristic of the fingerprint is consistent with the encrypted characteristic of the fingerprint acquired by analyzing or not, and if yes, allowing the second terminal to be connected to Wi-Fi.
